(19) United States
(12) Patent Application Publication
(10) Pub. No.: US 2020/0081597 A1
(43) Pub. Date: Mar. 12, 2020

(54) APPLICATION PROGRAM MANAGEMENT METHOD AND APPARATUS

(71) Applicant: ZTE CORPORATION, Shenzhen, Guangdong (CN)

(72) Inventor: HAIQING YAN, Shenzhen, Guangdong (CN)

(21) Appl. No.: 16/300,603

(22) PCT Filed: Jul. 22, 2016
(86) PCT No.: PCT/CN2016/091061

§ 371 Date: Jan. 17, 2019

(30) Foreign Application Priority Data
May 10, 2016 (CN) 201610304321.X

(51) Int. Cl. G06F 3/0488; G06F 3/0484; G06F 3/0481

(52) U.S. Cl. CPC G06F 3/0488; G06F 3/0481; G06F 3/04847

(57) ABSTRACT

An application program management method and apparatus. The method comprises: identifying a currently-triggered application program; obtaining an application management gesture; and performing corresponding application management according to the type of the identified currently-triggered application program and the obtained application management gesture, the type of the currently-triggered application program comprising: the currently-triggered application program being an original application or a new application, the new application being generated according to the original application, and the new application and the original application being different processes of a same application. In the technical solution in embodiments of the present disclosure, a new application is managed by using a gesture, and accordingly user experience can be improved.

### FIELD OF THE INVENTION

The disclosure relates to, but is not limited to, the technical fields of application management, and relates to an application management method and apparatus.

### BACKGROUND

Currently, in the commercially available mobile terminals based on Android (or other mobile operating systems), such as smart phones and tablets, an application can only start and run a process, rather than simultaneously run multiple processes for one application as in a computer. If the mobile terminal is required to run multiple processes of an application at the same time as a computer, it is necessary to use the application multi-open technology. The so-called multi-open means that when the mobile terminal loads to run an original application, it can run multiple new applications corresponding to the original application at the same time, wherein the new applications are essentially process under the system application management. For example, when a user operates a QQ original application in the mobile terminal, a plurality of new QQ applications (such as QQ1 and QQ2) based on the original QQ application may also be run in the mobile terminal. However, the related management operations for these new applications are cumbersome, resulting in poor user experience.

### SUMMARY

The outline of the subject matter will be described in detail hereinafter. The outline is not intended to restrict the protection scope of claims.

Embodiments of present disclosure provide an application program management method, which can promptly manage a new application, thereby improving user experience.

An embodiment of the disclosure provides an application program management method, comprising: identifying a currently-triggered application program; obtaining an application management gesture; and performing corresponding application management according to the type of the identified currently-triggered application program and the obtained application management gesture, wherein the type of the currently-triggered application program includes the currently-triggered application program being an original application or a new application, the new application is generated according to the original application, and the new application and the original application is different processes of a same application.

Optionally, the obtained application management gesture includes a new application creation gesture or a new application deletion gesture.

Optionally, the step of performing corresponding application management according to the type of the identified currently-triggered application program and the obtained application management gesture, comprises at least one of: creating a first new application corresponding to the currently-triggered application program according to the application management gesture in the case where it is identified that the currently-triggered application program is the original application; deleting a second new application that has been generated by the currently-triggered application program according to the application management gesture in the case where it is identified that the currently-triggered application program is the original application; creating a third new application according to the application management gesture in the case where it is identified that the currently-triggered application program is the new application, wherein the third new application and the currently-triggered application program correspond to the same original application; and deleting the currently-triggered application program according to the application management gesture in the case where it is identified that the currently-triggered application program is the new application.

Optionally, the step of identifying a currently-triggered application program comprises: obtaining a package name of the currently-triggered application program; and determining, according to the package name of the currently-triggered application program, whether the currently-triggered application program is the original application or the new application.

Optionally, the step of obtaining a package name of the currently-triggered application program comprises: obtaining, according to an icon location of the currently-triggered application program, a startup access parameter of the currently-triggered application program, wherein the startup access parameter includes the package name of the currently-triggered application program.

Optionally, the step of determining whether the currently-triggered application program is the original application or the new application comprises: querying an original application list and/or a new application list according to the package name of the currently-triggered application program; and determining that the currently-triggered application program is the original application in the case where an original application package name that completely matches the package name of the currently-triggered application program is found in the original application list and/or the new application list, and/or determining that the currently-triggered application program is the new application in the case where a new application package name that completely matches the package name of the currently-triggered application program is found in the new application list.

Optionally, the method further comprises: judging whether the currently-triggered application program satisfies a preset condition; and performing an operation of creating the first new application or performing an operation of creating the third new application in the case where the preset condition is satisfied, wherein in the case that the currently-triggered application program is the original application, the satisfaction of the preset condition means that a new application management tag of the currently-triggered application program is valid, and/or a gesture number of the currently-triggered application program is less than a preset threshold, or in the case that the currently-triggered application program is the new application, the satisfaction of the preset condition means that a new application management tag of the original application corresponding to the currently-triggered application program is valid, and/or a gesture number of the original application corresponding to the currently-triggered application program is less than a preset threshold.

Optionally, the step of creating a first new application corresponding to the currently-triggered application program comprises at least one of: starting the new process as the first new application according to the currently-triggered application program; adding information of the first new application to the new application list; creating an application icon and application name of the first new application on the desktop; and increasing the gesture number of the currently-triggered application program, and the step of creating a third new application comprises at least one of: starting the new process as the third new application according to the original application corresponding to the currently-triggered application program; adding information of the third new application to the new application list; creating an application icon and application name of the third new application on the desktop; and increasing the gesture number of the original application corresponding to the currently-triggered application program.

Optionally, the step of deleting a second new application that has been generated by the currently-triggered application program comprises at least one of: closing the second new application; deleting the information of the second new application from the new application list; deleting an application icon and application name of the second new application from the desktop; and decreasing the number gesture of the original application corresponding to the currently-triggered application program, and the step of deleting the currently-triggered application program comprises at least one of: closing the currently-triggered application program; deleting the information of the currently-triggered application program from the new application list; deleting an application icon and application name of the currently-triggered application program from the desktop; and decreasing he number gesture of the original application corresponding to the currently-triggered application program.

Optionally, the new application creation gesture or the new application deletion gesture is the same as or different from a gesture for triggering application program.

An embodiment of the disclosure provides an application program management device, comprising: an identification module, configured to identify a currently triggered application program; an obtaining module, configured to obtain an application management gesture; and an application management module, configured to perform corresponding application management according to the type of the currently-triggered application program identified and the application management gesture obtained, wherein a new application is generated according to an original application, and the new application and the original application is different processes of a same application.

Optionally, the obtaining module is configured to obtain a new application creation gesture or a new application deletion gesture.

Optionally, the application management module is configured to perform at least one of: creating a first new application corresponding to the currently-triggered application program according to the application management gesture obtained by the obtaining module in the case where the identification module identifies that the currently-triggered application program is the original application; deleting a second new application that has been generated by the currently-triggered application program according to the application management gesture obtained by the obtaining module in the case where the identification module identifies that the currently-triggered application program is the original application; creating a third new application according to the application management gesture obtained by the obtaining module in the case where the identification module identifies that the currently-triggered application program is the new application, wherein the third new application and the currently-triggered application program correspond to the same original application; and deleting the currently-triggered application program according to the application management gesture obtained by the obtaining module in the case where the identification module identifies that the currently-triggered application program is the new application.

Optionally, the identification module comprises: an obtaining unit, configured to obtain a startup access parameter of the currently-triggered application program according to an icon location of the currently-triggered application program, wherein the startup access parameter includes: a package name of the currently-triggered application program; and an identification unit, configured to query the original application list and/or new application list according to the package name of the currently-triggered application program, wherein in the case where the original application package name that exactly matches the package name of the currently-triggered application program is found in the original application list and/or the new application list, the identification unit determines that the currently-triggered application program is the original application, and/or, in the case where the new application package name that exactly matches the package name of the currently-triggered application program is found in the new application list, the identification unit determines that the currently-triggered application program is a new application corresponding to the original application.

Optionally, the device further comprises: a judgment unit, configured to judge whether the currently-triggered application program satisfies a preset condition; and a new application creation unit, configured to perform an operation of creating the first new application corresponding to the currently-triggered application program or perform an operation of creating the third new application in the case where the currently-triggered application program satisfies the preset condition, wherein in the case that the currently-triggered application program is the original application, the satisfaction of the preset condition means that a new application management tag of the currently-triggered application program is valid, and/or a gesture number of the currently-triggered application program is less than a preset threshold, or in the case that the currently-triggered application program is the new application, the satisfaction of the preset condition means that a new application management tag of the original application corresponding to the currently-triggered application program is valid, and/or a gesture number of the original application corresponding to the currently-triggered application program is less than a preset threshold.

Optionally, the application management module is configured to create the first new application by at least one of: starting the new process as the first new application according to the currently-triggered application program; adding information of the first new application to the new application list; creating an application icon and application name of the first new application on the desktop; and increasing the gesture number of the currently-triggered application program, and the application management module is configured to create the third new application by at least one of: starting the new process as the third new application according to the original application corresponding to the currently-triggered application program; adding information of the third new application to the new application list; creating an application icon and application name of the third new application on the desktop; and increasing the gesture number of the original application corresponding to the currently-triggered application program.

Optionally, the application management module is configured to delete the second new application that has been generated by the currently-triggered application program by at least one of: closing the second new application; deleting the information of the second new application from the new application list; deleting an application icon and application name of the second new application from the desktop; and decreasing the number gesture of the original application corresponding to the currently-triggered application program, and the application management module is configured to delete the currently-triggered application program by at least one of: closing the currently-triggered application program; deleting the information of the currently-triggered application program from the new application list; deleting an application icon and application name of the currently-triggered application program from the desktop; and decreasing he number gesture of the original application corresponding to the currently-triggered application program.

The beneficial effects of the present disclosure are as follows:

The above method and device can support gesture-based application management (create or delete) according to the identified application type (original application or new application), that is, support gesture management of the new application, thereby improving the management efficiency of new application and the user experience.

### BRIEF DESCRIPTION OF THE DRAWINGS

FIG. 1 is a flow chart schematically showing an application management method according to a first embodiment of the present disclosure;

FIG. 2 is a flow chart schematically showing Step 11 in FIG. 1 according to the embodiment;

FIG. 3 is a flow chart schematically showing an application management method according to a second embodiment of the present disclosure;

FIG. 4 is a block diagram schematically showing an application management apparatus according to an embodiment of the present disclosure;

FIG. 5 is a block diagram schematically showing an identification module in FIG. 4 according to the embodiment; and

FIG. 6 is a block diagram schematically showing an application management module in FIG. 4 according to the embodiment.

### DETAILED DESCRIPTION OF THE EMBODIMENTS

Embodiment of the present disclosure will be described in detail below with reference to the accompanying drawings. However, it will be understood by one ordinary person skilled in the art that in the various embodiments of the present disclosure, numerous technical details are set forth in order to better understand the present disclosure. However, the technical solutions claimed in the claims of the present disclosure can be implemented without these technical details and various changes and modifications based on each of the following embodiments.

The application multi-open means, an application creates multiple processes, wherein the original process may be referred to as “original application”, and other processes based on “original application” may be referred to as “new application (divide application)”. In the related art, when creating a new application, it is generally required to access to a setting page of the operating system to activate the multi-open corresponding to the application, start the new application in the background, and then return to the desktop launcher. At this time, an icon of the new application could be seen. The new application can be used by clicking the icon. When closing the new application, it is also necessary to access to the settings, close the multi-open, then close the new application process in the background, return to the desktop launcher, and then refresh the interface. At this time, the deletion of the new application icon could be seen. However, the above management operation on the new application is cumbersome, that is, the user needs to repeatedly access to the setting page to perform corresponding operations, thereby resulting in the inferior user experience. In view of this, embodiments of the present disclosure provide an application management method and apparatus that support gesture-based new application creation and shutdown. With the method according to the embodiments of the present disclosure, the new application can be quickly created and closed, thereby improving the user experience. Specifically, the management method of the application program according to the embodiments of the present disclosure will be described hereinafter.

### First Embodiment

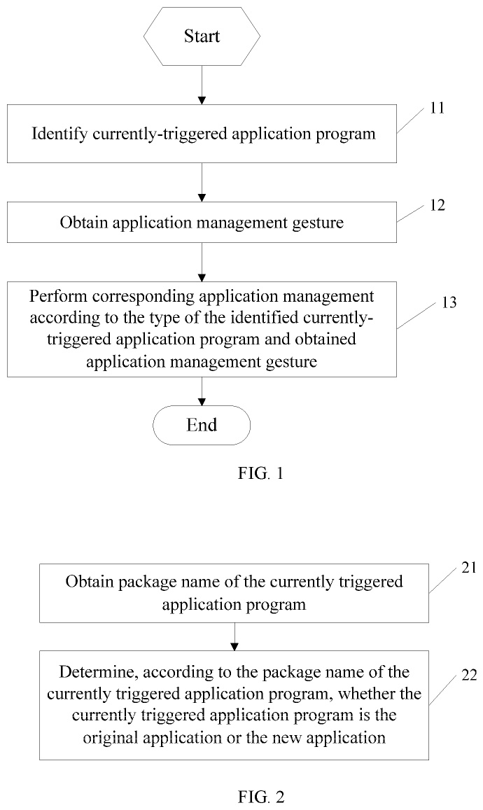

FIG. 1 is a flow chart schematically showing an application program management method according to a first embodiment of the present disclosure. In particular, the method includes:

Step 11: identifying a currently-triggered application program;

Step 12: obtaining an application management gesture; and

Step 13: performing corresponding application management according to the type of the identified currently-triggered application program and the obtained application management gesture.

Herein, at Step 11, the identification of the application program includes identifying whether the application program is an original application or a new application. Herein, it is known to those skilled in the art that the new application is generated according to the original application, and the new application and the original application are essentially different processes of the same application.

Optionally, at Step 12, the obtained application management gesture may include: a new application creation gesture or a new application deletion gesture. Herein, the application management gesture may be triggered by the user to indicate an application management operation desired by the user to the terminal. For example, the user provides the application management gesture to the terminal by operating on the touch screen of the terminal. The terminal can obtain the above application management gesture by detecting the operation of the user on the touch screen. For another example, creation of the new application gesture may be a two-finger-open gesture, and deletion of the new application gesture may be a two-finger-pinch gesture, but the disclosure is not limited thereto.

In addition, the operation for triggering the application program at Step 11 may be or may not be the application management gesture mentioned at Step 12. For example, when a user performs a two-finger-open gesture at an icon location of an application program, the two-finger-open gesture is simultaneously used to trigger the application program to the desktop UI (user interface) and to instruct the creation of the new application corresponding to application program. As another example, a user can perform an operation (not a two-finger-open gesture) at an icon location of an application program to trigger the application program to the desktop UI, and then input the two-finger-open gesture to program the creation of the new application corresponding to the application program.

Herein the application management involved at Step 13 includes: the creation of the new application and the deletion of the created new application. Specifically, Step 13 may include at least one of steps:

(1) creating a first new application corresponding to the currently triggered application program when it is identified that the currently triggered application program is an original application and a new application creation gesture is acquired;

(2) creating a third new application when it is identified that the currently triggered application program is a new application and a new application creation gesture is acquired, wherein the third new application and the currently triggered application program correspond to the same original application, that is, the third new application and the currently triggered application program are different new applications from the same original application;

(3) deleting the second new application that has been generated by the currently triggered application program when it is identified that the currently triggered application program is an original application and a new application deletion gesture is acquired; and

(4) deleting the currently triggered application program when it is identified that the currently triggered application program is a new application and a new application deletion gesture is acquired.

The operation of creating a new application (the first new application and the third new application) as mentioned above may include: starting a new process as the new application according to the original application; adding information of the new application to the new application list, which will be explained later; creating an application icon and application name of the new application on the desktop; and increasing the number of original application gestures (for example, by one).

The operation of deleting the new application as mentioned above may include: closing the process of the new application; deleting the information of the new application from the new application list; deleting the application icon of the new application from the desktop; and decreasing the number gesture of original application (for example, the number of gestures is decreased by 1).

In this embodiment, gestures can be used to manage the creation and deletion of new applications, such that new applications can be quickly created and closed, thereby improving the user experience.

With reference to FIG. 2, FIG. 2 is a flow chart schematically showing Step 11 in FIG. 1 according to the embodiment, including:

Step 21: obtaining a package name (such as an identification identifier) of the currently triggered application program; and

Step 22: determining, according to the package name of the currently triggered application program, whether the currently triggered application program is the original application or the new application.

Herein, at Step 21, a startup access parameter of the currently triggered application program may be obtained according to the icon location of the currently triggered application program, and the startup access parameter includes the package name of the currently triggered application program. It should be noted that the specific operations of obtaining the startup access parameters and the detailed information in the startup access parameters are known to those skilled in the art, and will not be described herein.

Herein, in this embodiment, there may be an original application list for recording related information of the original application, wherein the original application list at least includes: the original application package name. At Step 22, if the package name obtained at Step 21 can be completely matched with (completely identical to) any new application package name in the original application list, it can be identified that the currently triggered application program is the original application.

Herein, in this embodiment, there may be a new application list for recording related information of the new application, wherein the new application list at least includes: the new application package name. At Step 22, if the package name obtained at Step 21 can completely match with any new application package name in the new application list, it can be identified that the currently triggered application program is the original application. Since the new application is associated with the original application, when it is identified that the currently triggered application program is a new application, the original application corresponding to the new application may be determined by utilizing the relationship between the new application and the original application.

It should be noted that, since the new application is associated with an original application, the new application list generally includes: the new application package name and the original application package name. Therefore, the package name obtained at Step 21 can also be matched with the original application package name in the new application list. If an exact matching item can be found, the currently triggered application program can also be considered as the original application.

By means of the method of FIG. 2, it can be quickly queried whether the currently triggered application program is an original application or a new application.

In practical applications, not all original applications have requirements for creating a new application. For example, a system application generally cannot create a new application. Therefore, a new application management tag may also be provided in the original application in the embodiment of the present disclosure, and it is possible to create a new application of the original application only when the new application management tag of the original application is valid, wherein when the new application management tag of the original application is valid, the new application management tag is provided or the new application management tag is set to a predetermined value (such as “1”). In other words, when an original application does not have the new application management flag or the new application management flag is not set to a predetermined value (for example, set to “0”), a new application corresponding to the original application cannot be created. At this time, even if it is judged that the currently triggered application program is the original application and the gesture for creating a new application is received, the system does not take action or may prompt the user that the original application cannot create a new application.

In addition, in practical applications, the same original application is not suitable for creating too many new applications, otherwise it will affect system performance and thus affect the user experience. Therefore, the original application in the embodiment of the present disclosure may further correspond to a gesture number, which is used to record the number of new applications that have been created by the original application. For example, an initial value of the gesture number is 0. When the original application creates a new application, the initial value is incremented by one; when a new application of the original application is deleted, the gesture number is decremented by one. The gesture number may have a preset threshold. When the threshold is exceeded, the new application is no longer created.

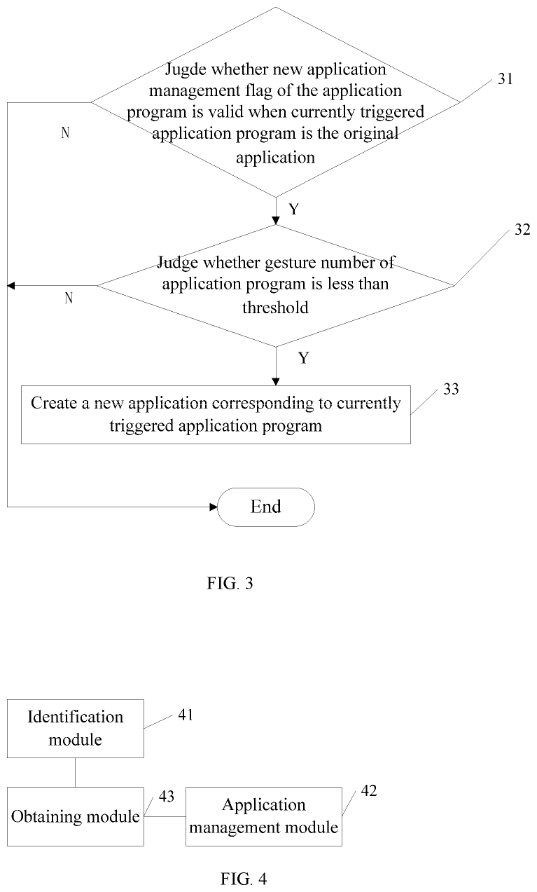

As shown in FIG. 3, the application program management method according to the embodiment of the present disclosure may include:

Step 31: when the currently triggered application program is the original application, judging whether the new application management flag of the application program is valid, wherein if valid, proceed with step 32, or if invalid, the process is closed.

It should be noted that if the currently triggered application program is a new application, the original application management flag corresponding to the currently triggered application program is judged. In other words, when the currently triggered application program is a new application, the original application corresponding to the new application is first obtained, and then it is judged whether the original application management flag corresponding to the original application is valid.

Step 32: proceeding to judge whether the gesture number of the application program is less than a threshold, wherein if it is less than the threshold, proceed to Step 33, or if it is not less than the threshold, the process is closed.

Step 33: creating a new application corresponding to the currently triggered application program, and closing the process.

Herein, Step 31 and Step 32 can learn the new application management tag and the gesture number through the original application list. Generally, the original application list may include: the original application package name, the original application management tag, and the gesture number. For example, the original application list is shown in Table 1:

TABLE 1

| Original application | New application | Gesture |
|---|---|---|
| package name | management tag | number |
| *** | *** | **** |

With the above-mentioned original application list, the condition of the new application management flag and the gesture number of the currently triggered application program can be easily obtained by using the package name obtained in the example shown in FIG. 2, thereby determining whether to proceed with Step 33.

In the present disclosure, in addition to the original application list, there may be a new application list, which may also be referred to as a derivative list of the original application list, and which may generally include information such as an original application package name, a new application package name, a new application icon, and new application name. Herein, the format of the new application package name is generally “original application package name +suffix”. For example, the new application list can be as shown in Table 2:

TABLE 2

| Original app | New app | Gesture | New | New |
|---|---|---|---|---|
| package name | package name | number | app icon | app name |
| *** | ***** | **** | *** | *** |

Therefore, Step 33 of creating a new application above generally includes: creating a process of the new application according to the original application, simultaneously generating information of the new application associated with the original application in the new application list, and then obtaining, through a desktop launcher, the new application name and the new application name in the new application list to display the new application icon and the new application name on the desktop. Herein, the new application icon is generally the same as the original application icon, and the new application name is generally the original application name+suffix. In addition, the gesture number corresponding to the original application in the original application list is also increased by one.

Accordingly, the operation of deleting the new application is similar. That is, the process of closing the new application, deleting the information of the new application from the new application list, and reducing the gesture number of the corresponding original application by one in the original application list. At the same time, the desktop launcher deletes the new application name and the new application icon of the desktop.

The application program management method according the embodiment of the present disclosure will be described hereinafter by way of WeChat application.

First, the mobile terminal stores an original application list including: a WeChat application package name, a corresponding new application management tag, and a gesture number, wherein the new application management flag is used to indicate whether the WeChat application can create a new application. The application, in the present embodiment, is able to be created. The gesture number is used to limit the number of opened new applications to control system overhead.

Secondly, the user triggers the WeChat application icon on the desktop, and the system UI obtains the WeChat application startup access parameter according to the WeChat icon location, and matches the WeChat in the original application list by full word by means of the WeChat application package name in the access parameter. If the WeChat application package name is matched, it is judged to be an original WeChat application; if only the partial WeChat application package name is matched, then the new application list is queried again to match a package name of WeChat 1 by full word, and if it is matched, it is judged to be a new application WeChat 1.

Furthermore, if the application is a WeChat original application, the new application management tag and the gesture number in the original application list will be checked. If the original application includes the new application management tag and the gesture number does not reach a threshold, the original application may generate a new application WeChat 1. In the case that the gesture obtained according to the system UI is a system-standard two-finger-open gesture (not limited to this gesture), the gesture number in the original list data is increased by 1, a new application process of running WeChat 1 is started, and the data of the WeChat 1 is added to the new application list (if not, then create a new application list) simultaneously. The added data may include data information such as WeChat application package name, the new application package name of WeChat 1 (original application package name+suffix), the application name of WeChat 1, the application icon of WeChat 1.

Step S104: obtaining, by the desktop launcher, an application name of WeChat 1 and an application icon of WeChat 1 in a derived list, and displaying the application icon of WeChat 1 on the desktop.

Moreover, in the case that the application is judged to be a new application WeChat 1 and the gesture obtained according to the system UI is a system-standard two-finger-pinch gesture, (not limited to this gesture), then the process of running WeChat 1 is closed, the data of WeChat 1 is deleted from the new application list, and the gesture number in the original application list is reduced by 1, the desktop launcher deletes the application name and the application icon of WeChat 1 on the desktop at the same time, and the application of WeChat 1 is closed.

### Second Embodiment

An embodiment of the present disclosure also provides an application program management device, suitable for a mobile terminal, such as a smart phone, a tablet computer, a notebook computer, a personal digital assistant, a car audio and video, and the like. The management device may correspond to any one of the above process embodiments. In other words, the details involved in the above process embodiments may be performed by the management device. Therefore, the summary of the management device is mainly described for brevity, and detailed description thereof will be omitted.

As shown in FIG. 4, the application program management device according to the embodiment of the present disclosure may include: an identification module 41, an application management module 42, and an obtaining module 43. The identification module 41 is configured to identify a currently triggered application program; the obtaining module 43 is configured to obtain an application management gesture; and the application management module 42 is configured to perform corresponding application management according to the type of the currently-triggered application program identified by the identification module 41 and the application management gesture obtained by the obtaining module 43.

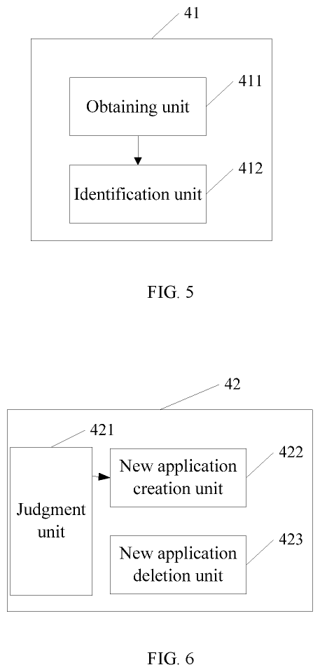

Optionally, as shown in FIG. 5, the identification module 41 includes: an obtaining unit 411, configured to obtain a startup access parameter of the currently-triggered application program according to an icon location of the currently triggered application program, wherein the startup access parameter includes: a package name of the currently triggered application program; and an identification unit 412 configured to query the original application list and/or new application list according to the package name of the currently-triggered application program. Herein, when the original application package name that exactly matches the package name of the currently triggered application program is found in the original application list and/or the new application list, the identification unit determines that the currently triggered application program is the original application, and/or, when the new application package name that exactly matches the package name of the currently triggered application program is found in the new application list, the identification unit determines that the currently triggered application program is a new application corresponding to the original application.

Optionally, as shown in FIG. 6, the application management module 42 includes: a judgment unit 421, a new application creation unit 422, and a new application deletion unit 423. The judgment unit 421 is configured to judge whether the original application satisfies a preset condition, wherein the preset condition may refer to the description of the above process embodiment. The new application creation unit 422 is configured to create a new application. The new application deletion unit 423 is configured to delete the new application. Herein, the creation and deletion of new applications can refer to the description as set forth above.

It should be noted that each of modules involved in the embodiments of the present disclosure is a logic module. In an actual application, a logic unit may be a physical unit, or may be a part of a physical unit, or may also be implemented by means of a combination of multiple physical units. In addition, in order to highlight the innovative part of the embodiments of the present disclosure, the units that are not closely related to solving the technical problem proposed by the present disclosure are not introduced, but this does not mean that there is no other unit in the embodiments.

Those skilled in the art can understand that all or part of the process of implementing the above embodiments may be completed by a computer program to instruct related hardware, and the program may be stored in a computer readable storage medium. The program, when executed, may include the flow of any one of the process embodiments as described above. The storage medium may be a magnetic disk, an optical disk, a Read-Only Memory (ROM), or a Random Access Memory (RAM), for example.

An embodiment of the present disclosure further provides a computer readable storage medium, wherein the computer readable storage medium stores computer executable instructions, and the computer executable instructions, when executed, implement an application program management method.

Those skilled in the art can understand that all or part of the steps in the above methods may be completed by a program to instruct related hardware (for example, a processor), and the program may be stored in a computer readable storage medium, such as a Read Only Memory, a magnetic disk or an optical disc. Alternatively, all or part of the steps in the above embodiments may also be implemented by at least one integrated circuit. Correspondingly, each module/unit in the above embodiments may be implemented in the form of hardware, for example, by an integrated circuit implementing its corresponding function, or may be implemented in the form of a software function module, for example, by executing a program/instruction implementing its corresponding function stored in a memory by a processor. This disclosure is not limited to any specific combination of hardware and software. A person skilled in the art should understand that the technical solutions of the present disclosure can be modified or equivalently replaced without departing from the spirit and scope of the technical solutions of the present disclosure, and should be included in the scope of the claims of the present application.

### INDUSTRIAL APPLICABILITY

The above technical solution can improve the user experience.

1. An application program management method, comprising:
identifying a currently-triggered application program;
obtaining an application management gesture; and
performing corresponding application management according to the type of the identified currently-triggered application program and the obtained application management gesture, wherein
the type of the currently-triggered application program includes the currently-triggered application program being an original application or a new application, the new application is generated according to the original application, and the new application and the original application is different processes of a same application.

2. The method according to claim 1, wherein the obtained application management gesture includes a new application creation gesture or a new application deletion gesture.

3. The method according to claim 1, wherein the step of performing corresponding application management according to the type of the identified currently-triggered application program and the obtained application management gesture, comprises at least one of:
creating a first new application corresponding to the currently-triggered application program according to the application management gesture in the case where it is identified that the currently-triggered application program is the original application;
deleting a second new application that has been generated by the currently-triggered application program according to the application management gesture in the case where it is identified that the currently-triggered application program is the original application;
creating a third new application according to the application management gesture in the case where it is identified that the currently-triggered application program is the new application, wherein the third new application and the currently-triggered application program correspond to the same original application; and
deleting the currently-triggered application program according to the application management gesture in the case where it is identified that the currently-triggered application program is the new application.

4. The method according to claim 1, wherein the step of identifying a currently-triggered application program comprises:
obtaining a package name of the currently-triggered application program; and
determining, according to the package name of the currently-triggered application program, whether the currently-triggered application program is the original application or the new application.

5. The method according to claim 4, wherein the step of obtaining a package name of the currently-triggered application program comprises:
obtaining, according to an icon location of the currently-triggered application program, a startup access parameter of the currently-triggered application program, wherein the startup access parameter includes the package name of the currently-triggered application program.

6. The method according to claim 4, wherein the step of determining whether the currently-triggered application program is the original application or the new application comprises:
querying an original application list and/or a new application list according to the package name of the currently-triggered application program; and
determining that the currently-triggered application program is the original application in the case where an original application package name that completely matches the package name of the currently-triggered application program is found in the original application list and/or the new application list, and/or
determining that the currently-triggered application program is the new application in the case where a new application package name that completely matches the package name of the currently-triggered application program is found in the new application list.

7. The method according to claim 3, further comprising:
judging whether the currently-triggered application program satisfies a preset condition; and
performing an operation of creating the first new application or performing an operation of creating the third new application in the case where the preset condition is satisfied, wherein
in the case that the currently-triggered application program is the original application, the satisfaction of the preset condition means that a new application management tag of the currently-triggered application program is valid, and/or a gesture number of the currently-triggered application program is less than a preset threshold, or
in the case that the currently-triggered application program is the new application, the satisfaction of the preset condition means that a new application management tag of the original application corresponding to the currently-triggered application program is valid, and/or a gesture number of the original application corresponding to the currently-triggered application program is less than a preset threshold.

8. The method according to claim 3, wherein the step of creating a first new application corresponding to the currently-triggered application program comprises at least one of: starting the new process as the first new application according to the currently-triggered application program; adding information of the first new application to the new application list; creating an application icon and application name of the first new application on the desktop; and increasing the gesture number of the currently-triggered application program, and
the step of creating a third new application comprises at least one of:
starting the new process as the third new application according to the original application corresponding to the currently-triggered application program; adding information of the third new application to the new application list; creating an application icon and application name of the third new application on the desktop;
and increasing the gesture number of the original application corresponding to the currently-triggered application program.

9. The method according to claim 3, wherein
the step of deleting a second new application that has been generated by the currently-triggered application program comprises at least one of: closing the second new application; deleting the information of the second new application from the new application list; deleting an application icon and application name of the second new application from the desktop; and decreasing the number gesture of the original application corresponding to the currently-triggered application program, and
the step of deleting the currently-triggered application program comprises at least one of: closing the currently-triggered application program; deleting the information of the currently-triggered application program from the new application list; deleting an application icon and application name of the currently-triggered application program from the desktop; and decreasing he number gesture of the original application corresponding to the currently-triggered application program.

10. The method according to claim 2, wherein the new application creation gesture or the new application deletion gesture is the same as or different from a gesture for triggering application program.

11. An application program management device, comprising:
an identification module, configured to identify a currently triggered application program;
an obtaining module, configured to obtain an application management gesture; and
an application management module, configured to perform corresponding application management according to the type of the currently-triggered application program identified and the application management gesture obtained, wherein the type of the currently-triggered application program includes the currently-triggered application program being an original application or a new application, the new application is generated according to the original application, and the new application and the original application is different processes of a same application.

12. The device according to claim 11, wherein the obtaining module is configured to obtain a new application creation gesture or a new application deletion gesture.

13. The device according to claim 11, wherein the application management module is configured to perform at least one of:
creating a first new application corresponding to the currently-triggered application program according to the application management gesture obtained by the obtaining module in the case where the identification module identifies that the currently-triggered application program is the original application;
deleting a second new application that has been generated by the currently-triggered application program according to the application management gesture obtained by the obtaining module in the case where the identification module identifies that the currently-triggered application program is the original application;
creating a third new application according to the application management gesture obtained by the obtaining module in the case where the identification module identifies that the currently-triggered application program is the new application, wherein the third new application and the currently-triggered application program correspond to the same original application; and
deleting the currently-triggered application program according to the application management gesture obtained by the obtaining module in the case where the identification module identifies that the currently-triggered application program is the new application.

14. The device according to claim 11, wherein the identification module comprises:
an obtaining unit, configured to obtain a startup access parameter of the currently-triggered application program according to an icon location of the currently-triggered application program, wherein the startup access parameter includes: a package name of the currently-triggered application program; and
an identification unit, configured to query the original application list and/or new application list according to the package name of the currently-triggered application program, wherein
in the case where the original application package name that exactly matches the package name of the currently-triggered application program is found in the original application list and/or the new application list, the identification unit determines that the currently-triggered application program is the original application, and/or, in the case where the new application package name that exactly matches the package name of the currently-triggered application program is found in the new application list, the identification unit determines that the currently-triggered application program is a new application corresponding to the original application.

15. The device according to claim 13, further comprising:
a judgment unit, configured to judge whether the currently-triggered application program satisfies a preset condition; and
a new application creation unit, configured to perform an operation of creating the first new application corresponding to the currently-triggered application program or perform an operation of creating the third new application in the case where the currently-triggered application program satisfies the preset condition, wherein
in the case that the currently-triggered application program is the original application, the satisfaction of the preset condition means that a new application management tag of the currently-triggered application program is valid, and/or a gesture number of the currently-triggered application program is less than a preset threshold, or
in the case that the currently-triggered application program is the new application, the satisfaction of the preset condition means that a new application management tag of the original application corresponding to the currently-triggered application program is valid, and/or a gesture number of the original application corresponding to the currently-triggered application program is less than a preset threshold.

16. The device according to claim 13, wherein
the application management module is configured to create the first new application by at least one of: starting the new process as the first new application according to the currently-triggered application program; adding information of the first new application to the new application list; creating an application icon and application name of the first new application on the desktop; and increasing the gesture number of the currently-triggered application program, and
the application management module is configured to create the third new application by at least one of: starting the new process as the third new application according to the original application corresponding to the currently-triggered application program; adding information of the third new application to the new application list; creating an application icon and application name of the third new application on the desktop; and increasing the gesture number of the original application corresponding to the currently-triggered application program.

17. The device according to claim 913, wherein
the application management module is configured to delete the second new application that has been generated by the currently-triggered application program by at least one of: closing the second new application; deleting the information of the second new application from the new application list; deleting an application icon and application name of the second new application from the desktop; and decreasing the number gesture of the original application corresponding to the currently-triggered application program, and
the application management module is configured to delete the currently-triggered application program by at least one of: closing the currently-triggered application program; deleting the information of the currently-triggered application program from the new application list; deleting an application icon and application name of the currently-triggered application program from the desktop;
and decreasing he number gesture of the original application corresponding to the currently-triggered application program.

18. The device according to claim 12, wherein the application management module is configured to perform at least one of:
creating a first new application corresponding to the currently-triggered application program according to the application management gesture obtained by the obtaining module in the case where the identification module identifies that the currently-triggered application program is the original application;
deleting a second new application that has been generated by the currently-triggered application program according to the application management gesture obtained by the obtaining module in the case where the identification module identifies that the currently-triggered application program is the original application;
creating a third new application according to the application management gesture obtained by the obtaining module in the case where the identification module identifies that the currently-triggered application program is the new application, wherein the third new application and the currently-triggered application program correspond to the same original application; and
deleting the currently-triggered application program according to the application management gesture obtained by the obtaining module in the case where the identification module identifies that the currently-triggered application program is the new application.
